(19) United States
(12) Patent Application Publication
(10) Pub. No.: US 2017/0075072 A1
(43) Pub. Date: Mar. 16, 2017

(54) Multiport Free-Space WDM Based On Relay Lens

(71) Applicant: XUEFENG YUE, San Jose, CA (US)

(72) Inventor: XUEFENG YUE, San Jose, CA (US)

(21) Appl. No.: 14/852,543

(22) Filed: Sep. 12, 2015

Related U.S. Application Data
(63) Continuation-in-part of application No. 14/852,542, filed on Sep. 12, 2015.

(51) Int. Cl. G02B 6/32; G02B 13/00; H04J 14/02

(52) U.S. Cl. CPC G02B 6/32; H04J 14/0227; G02B 13/0095

(57) ABSTRACT

The present invention is a lens system used to relay the light from one region to another and increase the workable optical path length to make Wavelength Division Multiplexing (WDM) devices with a high port count. Inside the WDM device based on thin filters, collimators produce parallel light beams, and when the light path is over the collimator working distance, there can be substantial coupling loss. However, within the working distance, light can pass through the filters and collimators to follow the zig-zag pattern and eventually couple into a desired fiber without substantial insertion loss. A lens relay system can increase the optical path length to achieve high port count DWDM without fiber routing that takes more space and without a high coupling loss that is caused by multiple coupling between free space and fibers.

### CROSS REFERENCE TO RELATED APPLICATIONS

This application is a continuation-in-part of and claims the benefit of priority to the U.S. patent application Ser. No. 14/852,540, entitled “ASSEMBLY OF STANDARD DWDM DEVICES FOR USE ON FREE-SPACE MULTIPORT DWDM DEVICES,” filed on Sep. 12, 2015, and the U.S. patent application Ser. No. 14/852,542, entitled “OPTICAL FILTER SUBASSEMBLY FOR COMPACT WAVELENGTH DEMULTIPLEXING DEVICE,” filed on Sep. 12, 2015, the contents of which are incorporated in their entirety by reference herein.

### FIELD OF THE INVENTION

The present invention generally relates to the field of fiber optic communications. More particularly, the invention relates to integrated subassemblies for Wavelength Division Multiplexing (WDM) and demultplexing devices to achieve improvements in optical layout design to efficiently assemble and operate compact WDM assemblies with high port number.

### BACKGROUND OF THE INVENTION

In optics, and more particularly in multiplexing of fiber optics, Arrayed waveguide gratings (AWG) are commonly used as optical (de)multiplexers in wavelength division multiplexed (WDM) systems. These devices are capable of multiplexing a large number of wavelengths into a single optical fiber, and they can increase the transmission capacity of optical networks quite considerably. The devices are based on a fundamental principle of optics and how light waves of different wavelengths interfere linearly with each other. To describe this in more detail: if each channel in an optical communication network uses light of a slightly different wavelength, then the light from a large number of these channels can be carried by a single optical fiber with negligible crosstalk between the channels. Thus, AWG's are used to multiplex channels of multiple wavelengths onto a single optical fiber at the transmission end. AWG's can also be used as demultiplexers to retrieve individual channels of different wavelengths at the receiving end of an optical communication networks and devices.

When compared to Thin-Film Filter (TFF) based Wavelength Division Multiplexing (WDM), there are some advantages and disadvantages when considering performance at standard operating temperature.

In comparison, Wavelength Division Multiplexing (WDM) consists of a method of combining multiple signals on lasers beams at various infrared wavelengths for transmission on to fiber optic media. Laser modulation controls the set of signals and each infrared channel carries several radio frequency signals using a method called time division multiplexing. With time division multiplexing (TDM) the signals are transmitted and received over a common signal path by means of synchronized switches at the end of the transmission lines. Each signal should appear on the line in an alternating pattern at only a fraction of time. The multiplexed IR channels are separated into the original signal at the destined fiber strand.

Using TDM in the infrared red (IR) channels, the signals that carry data can be transmitted at the same time on a single fiber. The concept of WDM was first published in the 1970s and development on fiber optics signal transmission with WDM systems limited to two IR channels per fiber. At the end of the fiber line the IR channels were separated or demultiplexed by a two wavelength filters. The cutoff wavelength was approximately halfway between the wavelengths of the two channels. As the fiber optic technology advanced, more than two multiplexed IR channels could be demultiplexed using cascaded dichroic filters. In turn, this gave rise to the coarse wavelength-division multiplexing (CWDM) and dense wavelength-division multiplexing (DWDM). DWDM devices use tightly spaced wavelengths in the range of 1450 to 1650 nanometers. CWDM devices use broader spaced wavelengths over the full range of 1260 to 1650 nanometers (a full range of single more fiber). Overall WDM, DWDM, and CWDM devices are based on the similar concept of using multiple wavelengths of light on a single fiber. The difference between them is the spacing of wavelengths, the number of channels, and the ability to amplify the multiplexed signals in the optical space.

A common three-port WDM device is widely used in the industry and convenient to describe the process of increasing the capacity of a single strand of optical fiber. In a WDM system, many different colors of light are combined by a WDM multiplexing device and placed in a single strand of fiber while each color is called a channel. Conversely on the receiving side, each color is separated into its own channel by using a WDM demultiplexing device. Thin film filters are used to pass and reflect the desired wavelengths of light. A collimator can be placed before the thin film filter to collimate the light to prevent a large and uncontrolled beam. With three fiber strands on the same side of the three-port WDM device, Fiber 1 may carry three wavelengths of light on a single strand of fiber. As light passes through the Fiber 1 and incident on to the thin film filters, certain wavelengths are reflected onto a Fiber 2 or Fiber 3. Some wavelengths will pass through the filters and be placed onto a Fiber on the opposite side of the filters. Furthermore, thin film filter based WDM's can be cascaded together to obtain higher channel counts including 4, 8, 16, and 32 channels. However for multi-channel WDM more space is required in a device due to the fiber routing and higher loss results due to multiple times of coupling between the free-space and the fiber.

In addition, to achieve a compact WDM device, a free space multi-port technology describes the thin film filters and individual fiber collimators or collimators set up in certain arrays, with the addition of mirrors to reflect light. The fibers are aligned in parallel and come from the same side of the WDM device as described similarly in a three-port WDM device. Along with the fibers, the filters need to be placed in parallel to the mirror to keep all the filters in line to realize the same AOI (angle of incidence).

In this type of assembly the mirror and filters are mounted to the same base plate component in a compact device, where side mount is needed. In this case, the filters and the mirror must have a very accurate cutting angle to make the filter surface parallel to the mirror surface and the angle between the coating surfaces and cutting surface must be well controlled.

Some advantages of using TFF-based WDM technology over Arrayed Waveguide Grating (AWG) for separating light in fiber optics include: better performance at low port count and lower cost at low port count. Also, the TFF-based WDM technology works passively and is more stable at operating temperature. Some disadvantages however, include a bigger footprint and high performance variation at different port. Also, TFF-based WDM is not possible for high port count.

With free space Multi-Port WDM devices, collimators are used to align the light beam. However, the small sized collimators have relatively short working distance since the size of the collimator directly affects the needed optical path length of WDM devices. When the port count increases, a direct correlation exists as the loss for the ports. With longer optical path length increases as well. To avoid this issue, multiple low port count WDM devices can be cascaded together. However, the disadvantage is a big footprint of cascaded WDM devices and greater loss due to the coupling of devices between the free-space and fibers.

Therefore, what is needed is a relay system that provides proper orientation of images when cascading low port WDM devices, transfers the light from one region to another more efficiently and without coupling between free space and fiber and thus the extra coupling loss.

### SUMMARY OF THE INVENTION

Accordingly, the present invention is a relay system used to transfer the light from one region to another in cascaded Wavelength Division Multiplexing (WDM) devices. The WDM device includes collimators at a particular length which are designed to fit inside a low port WDM device. Collimators produce parallel light beams, and when the light path is over the collimator working distance, there can be substantial insertion loss. However, within the working distance, light can pass through the filters and collimators to follow the zigzag pattern and eventually couple into a desired fiber without substantial insertion loss. A lens relay system can increase the optical path length when routing fibers without a high coupling loss.

### First Preferred Embodiment and Best Mode

A relay lens system using a C-Lens Based Relay Lens is used to direct light to a co-focal point. This relay lens system allows the WDM devices to be constructed and cascaded together without fiber routing and without a high coupling loss. A glass or metal tube is used as the base to hold two c-lenses with an appropriate gap as the focal point coincide. This method of assembly is easy to construct, handle, and can be used as the same mounting method to the base as that for the other optical components in the assembly of the WDM device. The collimators, for example, can be assembled to the base of the WDM device with similar mounting methods. A glass triangular block can be used to mount the optical components such as the collimators and C-Lens based Lens' to the base. The relay lenses are required to be fine tuned in terms of coordination and angle, therefore the cylindrical shape of the relay lens and using the glass triangular blocks combination allows the mounting method to have the freedom to adjust for coordinates and angle.

### Second Preferred Embodiment

A relay lens system using a Ball-Lens Based Relay Lens is used to direct light to a co-focal point. A half open glass or metal tube is used as the base to hold the two Ball-Lens' with an appropriate gap as the focal points coincide. As described in the first preferred embodiment, this method of assembly is also easy to construct, handle, and can be used as the same mounting method to the base as is done for the other optical components in the assembly of the WDM device. This Ball-lens relay system saves space to allow for a smaller footprint when constructing the WDM device. Also, the collimators, for example, can be assembled to the base of the WDM device with similar mounting methods. Again, a glass triangular block can be used to mount the optical components such as the collimators and Ball-Lens based Relay lens to the base. Similar to the design of the C-lens relays, the Ball-Lens Relays are required to be fine tuned in terms of coordination and angle, therefore the cylindrical shape of the relays and by using the glass triangular blocks combination allows the mounting method to have the freedom to adjust for coordinates and angle.

### Third Preferred Embodiment

A relay lens system using a Bi-Concave-Lens Based Relay Lens is used to direct light to a co-focal point. A half open glass or metal tube is used as the base to hold the two Ball-Lenses with an appropriate gap as the focal points coincide. As described in the first and second preferred embodiment, this method of assembly is also easy to construct, handle, and can be used as the same mounting method to the base as is done for the other optical components in the assembly of the WDM device. This Bi-Concave lens relay system saves space to allow for a smaller footprint when constructing the WDM device. Also, the collimators, for example, can be assembled to the base of the WDM device with similar mounting methods. Again, a glass triangular block can be used to mount the optical components such as the collimators and Bi-Concave Lens based Relay lens to the base. Similar to the design of the C-lens relays, and Ball Lens relays, the Bi-Concave Relays are required to be fine tuned in terms of coordination and angle, therefore the cylindrical shape of the relays and by using the glass triangular blocks combination allows the mounting method to have the freedom to adjust for coordinates and angle. Other objects, features, and advantages of the present invention will become apparent upon examining the following detailed description of an embodiment thereof, taken in conjunction with the attached drawings.

### BRIEF DESCRIPTION OF THE DRAWINGS

FIG. 1 is a side frame view of a 3-port DWDM device containing input port, Gradient Index lens, thin film filter, input port, upgrade port, and drop port. The side view is used to further explain the function of multiplexing and demultiplexing for separating and combining different wavelengths of light into a single strand of optical fiber.

FIG. 2 is an illustration of a multi-channel Dense Wavelength Division Multiplexing device by cascading more than two 3-port devices.

FIG. 3 is a top view illustration of a multiple low-port count WDM device. In this illustration, the 1×4 WDM can be cascaded together but the illustration is intended to show the disadvantage of current assemblies which have a big footprint and loss due to coupling between the free-space and fiber.

FIG. 4 is a side view illustration of light beams passing through one collimator and another illustration of a light beam passing through two collimators. The illustrations are intended to show the significance of a two-lens relay system to double the working distance and yet to avoid insertion loss caused by coupling between fee space and fiber.

FIG. 5 is a top view illustration of a 1×4 WDM device and how a relay lens assembled in the WDM device can be used to cascade 2 1×4 WDM devices. With this type of relay lens assembly, there is no need for fiber routing and coupling into the fiber.

FIG. 6 is a top view illustration of a C-lens based relay lens. This is one type of lens design for the relay lens system which can be incorporated into the assembly when combining WDM devices.

FIG. 7 is an isometric view illustration of a Ball lens based relay lens. This is yet another embodiment of the relay lens system in which a half open glass or metal tube can hold two ball lenses with the appropriate gap so that the focal points coincide.

FIG. 8 is an isometric view illustration of a Bi-Convex lens based relay lens. This is another embodiment of the relay lens system in which a half open glass or metal tube can hold two ball-lenses with appropriate gap with focal point coinciding. This assembly can be mounted to the base of the prism in the same shape as all other collimators.

FIG. 9 is a front view illustration of the relay lens system along with the glass triangle blocks. This view is intended to show the mounting method of the relay lens system as triangular blocks can be used to mount the relay lens to let the relay have alignment freedom.

### DETAILED DESCRIPTION OF THE DRAWINGS

While the present invention may be embodied in different, forms, designs, or configurations, for the purpose of presenting an understanding of the principles of the invention, references will be made to the embodiments illustrated in the diagrams and drawings. Specific language will be used to describe the embodiments. Nevertheless it is intended to show that no limitation or restriction of the scope of the invention is thereby intended. Any alterations and further implementations of the principles of this invention as described herein are as they would normally occur to one skilled in the art to which the invention relates.

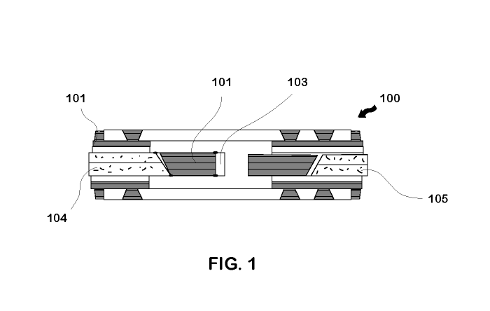

FIG. 1 is a side view of a 3-port Dense Wavelength Division Multiplexing device 100. The side view displays the positioning of the components along with the functionality of the device. Input port 1 shown by 101 uses combined colored light from a single fiber and separates light into individual fibers. Different wavelengths of colored light enter from the input port and pass through a gradient index GRIN lens 102. The GRIN lens 102 collimates the light so it will not diverge into a large uncontrolled beam while a thin film filter 103 is placed behind the gradient index lens 102 for filtering the wavelengths of the colored light. The reflected light travels to a different fiber in the upgrade port 104. Certain wavelengths will pass through the thin film filter 103 depending on the designed TFF used in the DWDM. The colored light enters from the Input port 101, incident to the TFF 102 with a small incident angle, is reflected back and focuses to another fiber as port 104. For example, if a single strand of fiber in the Input port has 3 wavelengths of colored light, the TFF selected can pass the wavelength of light into a single strand of fiber in the Drop port 105. The two other remaining wavelengths will be reflected into the port 104 and placed in separate individual fibers. As described above, the reflected light of the TFF 103 will offset the wavelengths in the vertical direction thus allowing the reflected light to enter separate strands of fiber in the Upgrade port 104. While this operation is called demultiplexing, multiplexing works in a similar way, except single strands of fibers carrying one wavelength of light, can be combined into a single strand of fiber carrying several different wavelengths.

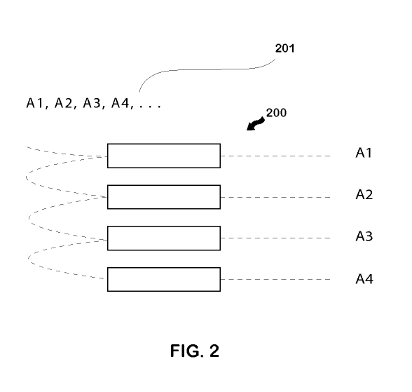

FIG. 2 is an illustration of a multi-channel Dense Wavelength Division Multiplexing device 200 by cascading multiple 3-port devices. Thin film filter based DWDM devices can be cascaded together to obtain higher channel counts such as 4, 8, 16, and 32 channels. Yet coupling the DWDM devices multiple times has its disadvantages. More space is used due to the fiber routing and a higher loss accrues between the free space and the single strands of fiber. The illustration shows the function of a multiplexing device where separate wavelengths are combined into a single strand of fiber. In this illustration for the benefit of clarity, four wavelengths of colored light indicated by A1, A2, A3, and A4 are shown to enter an input port and go through the filtering process to obtain a desired signal on a fiber optic link 201.

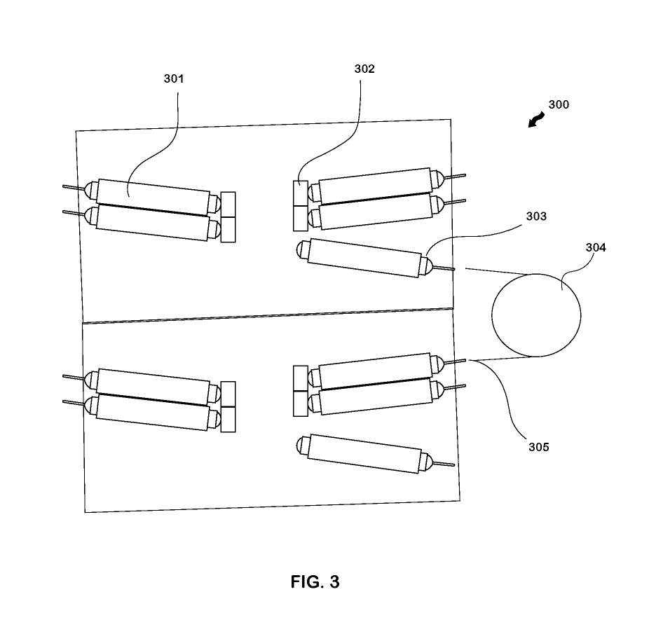

FIG. 3 is a top view illustration of the Free-space Wavelength Division Multiplexing device. In this configuration 1×4 WDM device is assembled, and the small size collimators 301 have a relatively short working distance. When selecting collimators, the length and size will affect the needed optical path length of WDM. With the increase of port count, the loss for the ports with longer optical path length will increase substantially. In order to avoid this issue, multiple low port count 1×4 WDM devices 300 can be cascaded but with the disadvantage of big footprint due to fiber routing and high loss due to coupling the devices between the free-space and fiber. A routed fiber 304is used typically to connect two collimators from one 1×4 WDM device to another 1×4 WDM device as shown in the illustration 300. The output of the first 1×4 WDM device 303 connects to the input of the next unit 305. With this type of assembly, the port count can be doubled without the enlarged working distance of fiber collimators. A 1×4 WDM can be cascaded to another but the fiber routing needs space and coupling from the free-space to fiber will introduce extra loss.

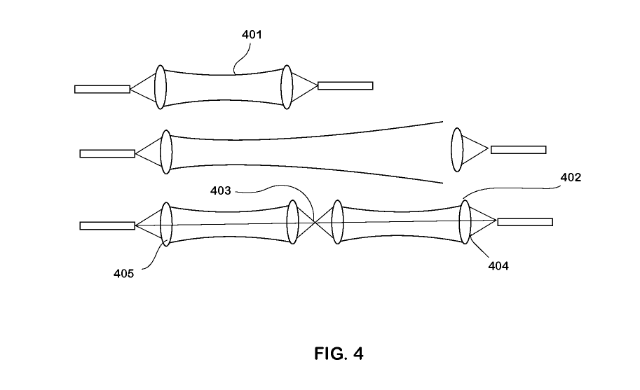

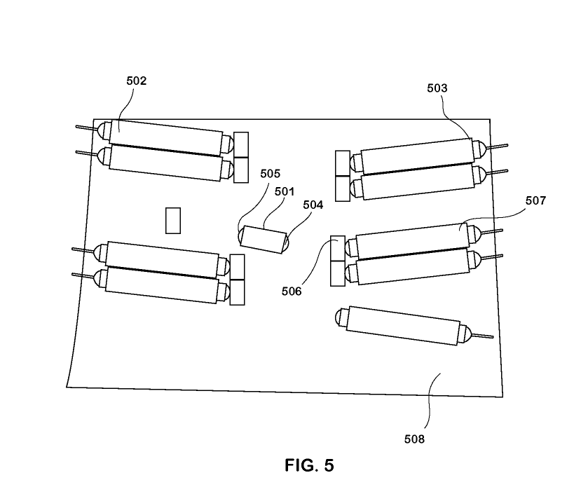

FIG. 4 is a side view illustration of the relay systems used for the present invention. The present invention uses relay systems to transfer the light from one region to another. When within the working distance, light can pass the TFF and follow the zigzag path to eventually couple into the optical fibers without substantial loss. This depends on the working distance of the collimator 401. Within the working distance light can pass through collimator, but when the light path length is over the collimator working distance, there is substantial loss. With the present invention, a two-lens relay system 402 can be double the optical path length and working distance without a high coupling loss. A relay lens 403 can be applied in between the two collimators 404 and 405 to create a co-focal point between the two collimators 404, and 405. A relay lens is used to repeat a collimated beam shape of a first collimator to double and triple the working distance. In addition, with the use of a relay lens, the coupling loss can be avoided. In FIG. 5, the top view of the relay lens 501 is illustrated and the functionality of the invention is described. Just as shown in FIG. 4, the relay lens 501, is used to help cascade a 1×4 WDM to form a 1×8 WDM. If the application requires more multiplexing, two 1×8 WDM devices can be cascaded to make a 1×16 WDM. With the use of the relay lens system, space on the base of the device can be saved by getting rid of fiber routing. Further, there is no need for fiber routing can coupling into the fiber. In FIG. 3, the standard method of coupling was described and the fiber was routed to connect two collimators. The relay lens system allows the port count to be doubled and there is no extra loss due to the free-space to fiber as seen in the industry standard method of assembly shown in FIG. 3.

In FIG. 5, 1×4 WDM device is shown and the first collimator 502 focuses a light beam through a thin film filter and into a second collimator 503. Light continues to pass through the remaining two collimators and into the relay lens 501. The focal point of the two lenses 503, and 504 coincide to avoid insertion loss and focus the light beam into the second 1×4 WDM device. As light passes through the thin film filter 506 and collimator 507 of the second 1×4 WDM device, the base or footprint 508 can remain relatively smaller while two 1×4 WDM devices are cascaded to form a 1×8 WDM device.

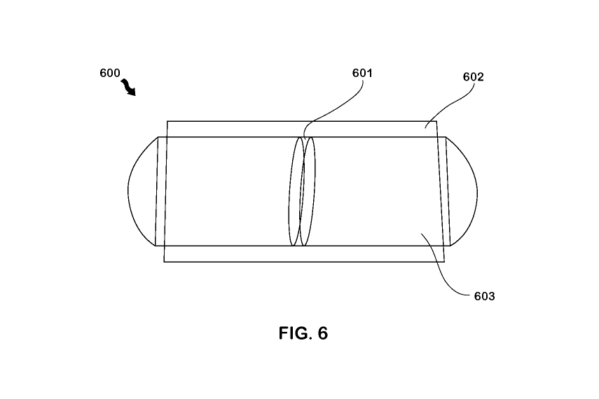

In FIG. 6 the C-lens Based Relays Lens 600 is shown in more particular detail. When cascading two 1×4 WDM devices to form a 1×8 WDM devices, a C-Lens Based Relay Lens can be used to combine the two devices. As described above, the present method of cascading WDM devices is by routing the fibers as shown in FIG. 3 to connect two collimators from separate WDM devices. With this, the port count can be doubled without enlarging the working distance of fiber collimators, however the fiber routing needs extra space and the coupling of WDM devices from free space to fiber introduces extra loss. One advantage of the present invention is to have the C-Lens Based Relay lens 600 assembled onto the base of the WDM device and keep the overall footprint of the assembly smaller. The working distance is also smaller thus reducing extra insertion loss. Two C lenses 603 are positioned with an appropriate gap in a glass or metal tube 602 cut in half. Each of the two lenses can be adjusted to fit the appropriate distance so that the focal points of each of the lenses coincides 601. When the focal points of each of the lenses coincide, the working distance of the fibers become less and the overall footprint of combining two or more 1×4 WDM devices becomes less. This saves space for a more condensed assembly, and removes insertion loss.

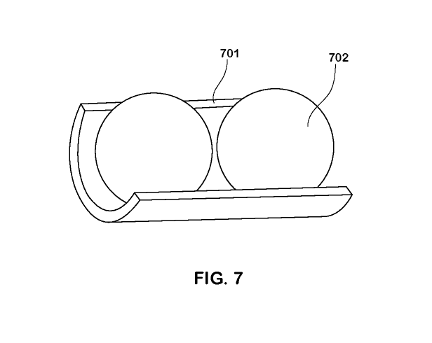

Another embodiment of the invention is shown in FIG. 7 in which a Ball-Lens Based Relay Lens system is shown. As described above in FIG. 6, when cascading two 1×4 WDM devices to form a 1×8 WDM devices, a Ball-Lens-Based Relay Lens can be used to combine the two devices. Since the present method of cascading WDM devices is by routing the fibers as shown in FIG. 3 to connect two collimators from separate WDM devices, and thus allowing the port count to be doubled without enlarging the working distance of fiber collimators. However, the fiber routing needs extra space and the coupling of WDM devices from free space to fiber introduces extra loss. One major advantage of the present invention is to have the Ball-Lens Based Relay lens 700 assembled onto the base of the WDM device and keep the overall footprint of the assembly smaller. The working distance is also smaller thus reducing extra insertion loss. Two Ball-Lens shaped lenses 702 are positioned with a particular gap in a glass or metal tube 701. Each of the two lenses can be adjusted to fit the appropriate distance so that the focal points of each of the lenses coincide. When the focal points of each of the lenses coincide, the working distance of the fibers become less and the overall footprint of combining two or more 1×4 WDM devices becomes less. This saves space for a more condensed assembly, and removes insertion loss.

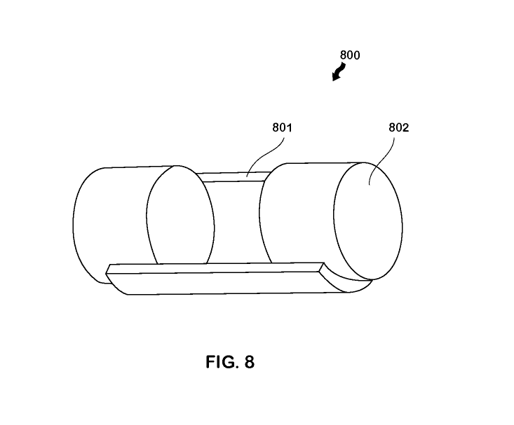

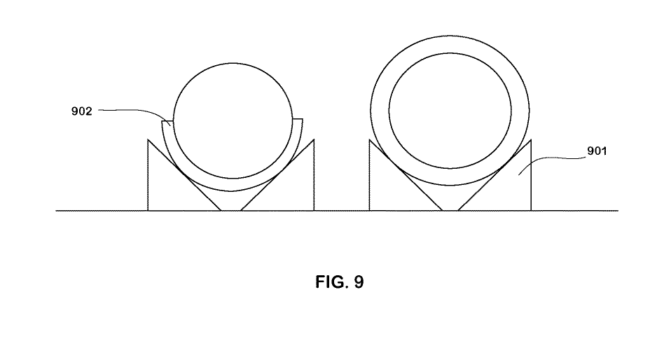

Yet another embodiment of the invention is shown in FIG. 8 in which a Bi-Convex-Lens Based Relay Lens system is shown. As described above in FIGS. 6 and 7, when cascading two 1×4 WDM devices to form a 1×8 WDM device, a Bi-Concave-Lens-Based Relay Lens can be used to combine the two devices. Since the present method of cascading WDM devices is by routing the fibers as shown in FIG. 3 to connect two collimators from separate WDM devices, and thus allowing the port count to be doubled without enlarging the working distance of fiber collimators. However, the fiber routing needs extra space and the coupling of WDM devices from free space to fiber introduces extra loss. One major advantage of the present invention is to have the Ball-Lens Based Relay lens 800 assembled onto the base of the WDM device and keep the overall footprint of the assembly smaller. The working distance is also smaller thus reducing extra insertion loss. Two Bi-Concave-Lens shaped lenses 802 are positioned with a particular gap in a glass or metal tube 801. Each of the two lenses can be adjusted to fit the appropriate distance so that the focal points of each of the lenses coincide. When the focal points of each of the lenses coincide, the working distance of the fibers become less and the overall footprint of combining two or more 1×4 WDM devices becomes less. This saves space for a more condensed assembly, and removes insertion loss. All three shapes for lenses described in FIGS. 6, 7, and 8 can be mounted directly to the base plate of the WDM device. A glass triangular block as shown in FIG. 9, 901, can be used to mount the glass tube and lenses to the base plate. Two glass triangular blocks 901, as shown in FIG. 9, can be mounted to the base plate. A glass tube 902 can then be mounted to the triangular blocks 901 and the relay lens system can have alignment freedom. The relays need to be fine tuned in terms of coordination and angle to ensure that the focal points coincide. Thus, the cylindrical shape of the relays plus the glass triangular block combination allows the mounting method to have both freedoms of coordination and angle. Once the positions of the relay lenses are fixed to the desired location, they will be mounted permanently to the desired position.

Although one or more embodiments of the newly improved invention have been described in detail, one of ordinary skill in the art will appreciate the modifications to the material selection and optical components along with the new footprint layout of the cascaded WDM devices. In particular, by using the relay lens system, an easier assembly and smaller footprint is created to cascade one or more 1×4 WDM devices. It is acknowledged that obvious modifications will ensue to a person skilled in the art. The claims that follow will set out the full scope of the claims.

1. An optical assembly, comprising:
a mounting plate;
a first optical alignment device placed on the mounting plate, wherein the first optical alignment device accepts a first light beam and outputs a second light beam;
a second optical alignment device placed on the mounting plate, wherein the second optical alignment device accepts the second light beam and outputs a third light beam; and
a relay lens placed on the mounting plate, wherein the relay lens accepts the second light beam and either directly relays the second light beam toward the second optical alignment device or indirectly relays the second light beam toward the second optical alignment via at least one intermediate device.

2. The optical assembly of claim 1, further comprising at least a reflector placed on the mounting plate, the reflector accepting the second light beam from the first optical alignment device and directing the second light beam toward the relay lens, the reflector can also accept the second light beam from the relay lens and direct the second light beam toward the second optical alignment device.

3. The optical assembly of claim 1, wherein the relay lens includes:
a tube; and
at least one lens element placed in the tube and includes a focus point, wherein the lens element accepts the second light beam and relays the second light beam toward the second optical alignment device.

4. The optical assembly of claim 3, wherein the lens element includes a first lens element and a second lens element placed in the tube, the focal point is located within the tube and between the first lens element and the second lens element.

5. The optical assembly of claim 3, wherein the lens elements include a C lens, a ball lens, and a bi-convex lens.

6. The optical assembly of claim 3, wherein the relay lens further includes a base to be mounted on the mounting plate, the tube is placed on the base.

7. The optical assembly of claim 6, wherein the base includes two blocks placed on the mounting plate, the blocks form a securing gap between the blocks, the tube is placed on the securing gap with an outer surface of the tube being in contact with the blocks.

8. The optical assembly of claim 3, wherein the tube is a U-shaped tube and has an opening.

9. A method of manufacturing an optical assembly, comprising steps of:
placing a first optical alignment device on a mounting plate set, wherein the first optical alignment device accepts a first light beam and outputs a second light beam;
placing a second optical alignment device on the mounting plate set, wherein the optical alignment device accepts the second light beam and outputs a third light beam; and
placing a relay lens for accepting the second light beam and then either directly relaying the second light beam toward the second optical alignment device or indirectly relaying the second light beam toward the second optical alignment device via at least one intermediate device.

10. The method of claim 9, further comprising a step of:
placing at least a reflector on the mounting plate set for accepting the second light beam from the first optical alignment device and directing the second light beam toward the second the relay lens, wherein the reflector can also accept the second light beam from the relay lens and direct the second light beam toward the second optical alignment device.

11. The method of claim 9, further comprising a step of:
manufacturing the relay lens by placing at least one lens element in a tube to create a focus point within the relay lens, wherein the lens element accepts the second light beam and relays the second light beam toward the second optical alignment device.

12. The method of claim 11, wherein the step of manufacturing the relay lens includes a step of:
placing a first lens element and a second lens of the lens element in the tube, wherein the focal point is located within the tube and between the first lens element and the second lens element.

13. The method of claim 11, wherein the step of manufacturing the relay lens includes choosing the lens element from at least one of a C lens, a ball lens, and a bi-convex lens.

14. The method of claim 11, wherein the step of manufacturing the relay lens includes steps of:
mounting a base on the mounting plate set; and
placing the tube of the relay lens on the base.

15. The method of claim 11, wherein the step of manufacturing the relay lens includes steps of:
placing two blocks on the mounting plate set to form a securing gap between the blocks; and
placing the tube in the securing gap with an outer surface of the tube being in contact with the blocks.

16. The method of claim 15, wherein the step of manufacturing the relay lens includes cutting a portion of the tube to form an opening and making the tube a U-shaped tube.

17. The method of claim 9, further comprising:
placing the first optical alignment device on a first mounting plate of the mounting plate set;
placing the second optical alignment device on a second mounting plate of the mounting plate set; and
placing the relay lens on the first mounting or the second mounting plate.

18. An optical assembly, comprising:
a first optical subassembly, including:
a first mounting plate; and
a first optical alignment device placed on the first mounting plate, wherein the first optical alignment device accepts a first light beam and outputs a second light beam;
a second optical subassembly, including:
a second mounting plate; and
a second optical alignment device placed on the second mounting plate, wherein the second optical alignment device accepts the second light beam and outputs a third light beam; and
a relay lens placed on the first mounting plate or the second mounting plate, wherein the relay lens accepts the second light beam and either directly relays the second light beam toward the second optical alignment device or indirectly relays the second light beam toward the second optical alignment device via at least one intermediate device.

19. The optical assembly of claim 18, further comprising a reflector placed on the first mounting plate or the second mounting plate, the reflector accepting the second light beam from the first optical alignment device and directing the second light beam toward the relay lens, the reflector can also accept the second light beam from the relay lens and direct the second light beam toward the second optical alignment device.

20. The optical assembly of claim 18, wherein the relay lens includes:
a tube;
at least one lens element placed in the tube and includes a focus point, wherein the lens element accepts the second light beam and relays the second light beam toward the second optical alignment device;
a base to be mounted on the first mounting plate or the second mounting plate, wherein the tube is placed on the base.
